(19) United States
(12) Patent Application Publication
(10) Pub. No.: US 2010/0311407 A1
(43) Pub. Date: Dec. 9, 2010

(54) RESOLVING CONFLICTING PHYSICAL CELL IDENTIFICATION IN A WIRELESS COMMUNICATION SYSTEM

(75) Inventors: Yi-Zhi Yao, Beijing (CN); Luis Lopes, Swindon (GB); Paul M. Stephens, Swindon (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/479,949

(22) Filed: Jun. 8, 2009

(51) Int. Cl. H04W 4/00

(52) U.S. Cl. 455/422.1

(57) ABSTRACT

A system and method for resolving conflicting physical cell identification in a wireless communication system includes a first step 200-204 of detecting a physical cell identification conflict. A next step 206 includes correcting a neighbour relation table in response to the conflict. A next step 208 includes receiving an ambiguous physical cell identification. A next step 210 includes resolving the ambiguous physical cell identification.

### FIELD OF THE INVENTION

The invention relates to wireless communication systems, and in particular to physical cell identification in a wireless communication system.

### BACKGROUND OF THE INVENTION

Currently 3^{rd} generation (3G) cellular communication systems based on Code Division Multiple Access (CDMA) technology, such as the Universal Mobile Telecommunication System (UMTS), are being deployed, and 4^{th} generation (4G) communication systems such as Worldwide Interoperability for Microwave Access (WiMAX) and Long Term Evolution (LTE) are being planned. The current trend is towards introducing a large number of cells in these communication systems, and a widespread introduction of such systems would result in a very large number of small cells that will need individual identification.

In the 4G LTE system, cells are identified by both a E-UTRAN cell global identification (ECGI) similar to the Global System for Mobile (GSM) Cell ID as is presently used, and also a short form called the Physical Cell ID (PCID). User equipment (UE) in idle mode only sees the PCID. The problem with the PCID is that it has a cardinality of 504, and therefore careful planning is required to ensure that there is no identity confusion with neighbouring cells that might share the same PCID, due to the limited cardinality of the PCID and a possibly large number of other cells.

In addition, as new cells are added to the network a conflict in PCIDs may arise where the same PCID is chosen for different cells within or near the same serving region. The conflicting PCIDs can lead to the wrong neighbour relations being maintained, and the conflicting PCIDs can result in target ambiguity preventing the mobile station from uniquely identifying a potential handover target, which can cause a handover failure if the UE attempts to handover to the wrong target. Although global cell identifications can be obtained, it would be impractical for a serving base station to ask one of its mobile stations to report the global cell identification for every measurement report of neighbouring cells, due to the air interface load.

For example, due to load considerations, a serving base station will not ask one of its mobile stations to report the global cell identification for every measurement report of neighbouring cells. This will cause the following problems in case of PCID collision and confusion: 1) If a cell with a PCID is no longer a real neighbour of a local cell, but is actually a new neighbour cell with the same PCID, the neighbour list will maintain the wrong (previous) cell identification, and this will easily cause handover failures. 2) If more than one cell with the same PCID are real neighbours of a local cell and those cells are in neighbour list, the ambiguity of a target cell with the same PCID may cause a handover failure if the cell selected for handover is in a bad signal situation. This situation may also cause the incorrect maintenance of the neighbour list by the base station, e.g., incorrect removal of the proper neighbour.

One solution to this problem is to utilize centralised radio frequency planning tools for frequency planning and managing cell identifications. However, this is difficult to implement due to reasons such as the nature of cells that can appear and disappear from the network quite rapidly and in large numbers. This solution is also expensive in that it requires substantial interaction by planners and operators, as the plan is initially created in an external model of the network, and this model needs to be kept up to date with the real sites on the ground.

Another solution would have a new cell first scan the radio environment so that it detects PCIDs already being used. However, this would require a large amount of scanning and would require a downlink scanning receiver, and would still not guarantee a unique PCID for the cell. A scanning receiver is an additional requirement and it may not always provide good data (depending on antenna mounting, it may give a much smaller or much bigger coverage area than the actual cell).

Another solution would have unique temporary PCIDs allocated on a queue basis by an operation, administration and maintenance system (OAM system). The temporary PCIDs are reserved and unused so the cell can safely come up and measure the neighbour cells. Although an improvement in the art, the lease of temporary PCIDs means that some PCIDs must be reserved. The more PCIDs that are reserved, the faster the introduction of a new eNBs must be done (noting that the lease must last for as long as it takes for an eNB to reach high confidence in a permanent PCID, which could take a long time). In addition, the use of reserved PCIDs leaves fewer PCIDs available for permanent allocations.

Even though the above solutions for PCID assignment are helpful to avoid the PCID conflicts, they can not effectively and totally resolve the problem in the network, and PCID conflicts can still occur.

Therefore, what is needed is a technique to detect potential PCID conflicts of neighbouring cells, resolve the ambiguity of a shared PCID, and avoid a handover to the wrong target neighbour. Conflicts to be resolved are collision and confusion between cells having the same PCID.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 illustrates an example of a communication system in accordance with the present invention; and

FIG. 2 illustrates an example of a method, in accordance with some embodiments of the invention.

Skilled artisans will appreciate that common but well-understood elements that are useful or necessary in a commercially feasible embodiment are typically not depicted or described in order to facilitate a less obstructed view of these various embodiments of the present invention.

### DETAILED DESCRIPTION OF EMBODIMENTS OF THE INVENTION

The present invention provides a technique to detect potential PCID conflicts of neighbouring cells, resolve the ambiguity of a shared PCID, and avoid a handover to the wrong target neighbour. This includes resolving PCID collision and confusion conflicts between cells having the same PCID.

The following description focuses on embodiments of the invention applicable to 4G communication systems such as LTE and WiMAX. For example, the present invention can be implemented for LTE evolved NodeBs (eNB) and LTE centralised-Self Organizing Networks (SON) where the functionality is lightweight enough so that it could be hosted on different network elements. The present invention could also be applied to the WiMAX base stations. However, it will be appreciated that the invention is not limited to these applications but may be applied to many other cellular communication systems such as a 3GPP (Third Generation Partnership Project) E-UTRA (Evolutionary UMTS Terrestrial Radio Access) standard, a 3GPP2 (Third Generation Partnership Project 2) Evolution communication system, a CDMA (Code Division Multiple Access) 2000 1×EV-DV communication system, a Wireless Local Area Network (WLAN) communication system as described by the IEEE (Institute of Electrical and Electronics Engineers) 802.xx standards, for example, the 802.11a/HiperLAN2, 802.11g, 802.16, or 802.21 standards, or any of multiple other proposed ultrawideband (UWB) communication systems.

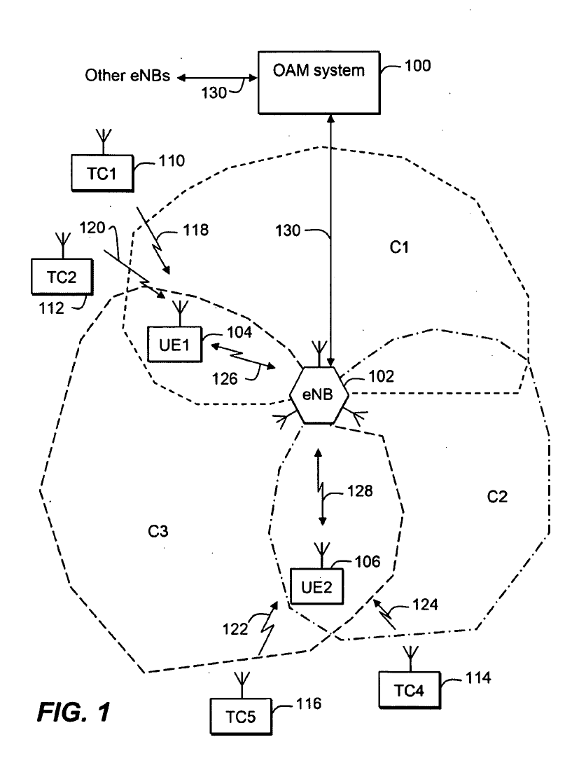

FIG. 1 illustrates an example of a cellular communication system which in the specific example is a 4G LTE communication system. In the system, cells are supported by base stations, such as eNB 102. The communication system can includes multiple user equipment (UE1 104 and UE2 106), such as but not limited to a cellular telephone, a radio telephone, a personal digital assistant (PDA) with radio frequency (RF) capabilities, or a wireless modem that provides RF access to digital terminal equipment (DTE) such as a laptop computer. Furthermore, cells can also be supported by base stations, which can include wireless access points, NodeBs, Home NodeBs, eNodeBs, Home eNodeBs, or other type of wireless base stations, for example, collectively referred to herein as eNBs.

The eNBs provide communication services to each UE residing in its coverage area, such as a cell of a 4G radio access network, via a wireless communication interface. Cells may share the same site. Each eNB of the cell(s) includes a transceiver or a Base Transceiver Station (BTS) for each cell, in wireless communication with each UE and further includes a network controller, such as a Radio Network Controller (RNC) or Base Station Controller (BSC), coupled to the transceiver. The transceiver and controller can each include a respective processor, such as one or more microprocessors, microcontrollers, digital signal processors (DSPs), combinations thereof or such other devices known to those having ordinary skill in the art. The particular operations/functions of processors, and respectively thus of the transceiver and controller, are determined by an execution of software instructions and routines that are stored in a respective at least one memory device, as are known in the art, associated with the processor, such as random access memory (RAM), dynamic random access memory (DRAM), and/or read only memory (ROM) or equivalents thereof, that store data and programs that may be executed by the corresponding processor.

Each UE also includes a processor, such as one or more microprocessors, microcontrollers, digital signal processors (DSPs), combinations thereof or such other devices known to those having ordinary skill in the art. The particular operations/functions of the processor, and respectively thus of UE, is determined by an execution of software instructions and routines that are stored in a respective at least one memory device associated with the processor, such as random access memory (RAM), dynamic random access memory (DRAM), and/or read only memory (ROM) or equivalents thereof as are known in the art, that store data and programs that may be executed by the corresponding processor. The UE also has the processor coupled to a transceiver for communicating over the air interface with the eNB.

Under the control of an eNB 102, here shown with three cells, C1 through C3, a UE 104, 106 can periodically obtain the PCIDs 118-124 from target cells TC1 through TC4 110-116 of neighbouring eNBs. The UE 104, 106 can then report these PCIDs to its serving eNB 102 in order to construct a neighbour list. The serving eNB 102 can then notify an OAM system 100 about changes including addition, modification and deletions in the neighbour list. Although only one eNodeB 102 and OAM system 100 is shown here, for simplicity, it should be recognised that there can be many other network entities in the communication system including other eNBs, a mobile switching centre, network gateway, radio network controller, etc. These are not shown for the sake of simplicity. The OAM system 100 controls the operating parameters of the system. The eNodeB 102 includes an Automatic Neighbour Relation (ANR) function that can be included within the eNodeB 102 or can be a separate entity. The ANR will generate a neighbour relations table (NRT) from all the reports received from the UEs plus any other relevant data, and may be used to update the neighbour lists.

In typical operation, a UE 104 is served by a serving eNB 102. The UE 104 receives 126 neighbour list information 130 sent by the OAM system 100 through the eNB 102. The neighbour list indicates neighbouring cells 110, 112. The UE 104 can then take measurements of the neighbouring cells 110, 112, and can also determine 118, 120 the PCIDs of its neighbouring cells 110, 112 of the neighbour list. The UE 112 then generates a message that includes the cell PCID (and pilot signal measurement results), which is transmitted 126 from the UE 104 to the eNB 102. The eNB 102 may use such reports to confirm the presence of cells 110, 112 in its Neighbour Relations Table and/or broadcast neighbour list, and provide such information to the OAM system 100.

Although this process is straightforward in fixed communication systems, cells can be added, moved, or removed quite easily, possibly resulting in conflicting PCIDs being assigned, and thereby making unique identification of neighbouring cells problematic for the eNB 102 and OAM system 100. For example, UE1 104 is operating under cell C3, and can report 126 measured neighbours TC1 110 and TC2 112, and UE2 106 (also operating under cell C3) can report measured neighbours TC4 114 and TC5 116. In one scenario it is supposed that TC1 110 and TC4 114 have identical PCIDs. Measurement reports that include TC1 110 can also include a measurement report of the local C1 cell. Measurement reports that include TC4 114 can also include a measurement report of the local C2 cell. From the measurement reports, measured neighbours can be added to the neighbour list (if the PCID of the neighbour is not present in the neighbour list) including any of the local co-sited cells that were reported in the same measurement report. The updated neighbour list can then be forwarded to the OAM system 100. Although neighbours with identical PCIDs can not be added into the NRT by the ANR, these identical PCID neighbours can be added into the NRT by OAM system 100, thereby resulting in a PCID conflict.

If there are identical PCIDs in the NRT of cell C3, the present invention provides for different resolutions depending upon the circumstances. In one scenario, a previous neighbour with a particular PCID is no longer a neighbour of a local cell. However, a new neighbour is present that happens to have the same PCID as the previous neighbour cell. In this scenario, the NRT will have a PCID listing for the wrong cell, which can cause handover failure. Since the PCID assignment is done by the OAM system by a centralized technique, or notified to the OAM system if the PCID is selected from the PCID list offered by OAM system by distributed technique, and the OAM system recognizes the changes of PCID done by an eNB via a notification/report message or done by the OAM system itself, the OAM system may be able to recognize the potential PCID confusion. In addition, since the OAM system actually knows the ECGI (E-UTRAN Global Cell ID), it will be able to recognize the potential PCID confusion. Further, for network planning and network management, the OAM system will also know other general information regarding the eNB and cells, for example the coverage and location, and the orientation of the cells. So for one cell, if one neighbour is gone, or the PCID of this neighbour is changed, the OAM system will be able to recognize this PCID confusion. And if the same PCID was just assigned to another neighbour but with different ECGI, the OAM system will need to correct it in NRT. Therefore, in any of the above cases, the OAM system will change the PCID listing in the NRT for the correct cell, in order to correct the PCID confusion.

In a second scenario, an eNB may find two identical PCIDs in its neighbour list (that was either assigned by the OAM system or built by the eNB from its UE reports). In this scenario, the eNB needs to detect whether the same PCID emanates from more than one cell. In other words there may actually be two real neighbours with the same PCID or there may just be two reports of the same cell's PCID. Referring to FIG. 1, UE1 may be operating in cell C1 and report the PCID for TC1, TC2 and cell C3 to its eNB, while UE2 may be operating in cell C2 and report the PCID for TC4, TC5, and cell C3 to its eNB (the same eNB as UE1's eNB). In this case, the same PCID for cell C3 was submitted by different reports, which can result in the same PCID being listed twice in the neighbour list of that eNB, even though it emanates from only one cell. The eNB can resolve this collision in two ways. First, the eNB can ask for a global cell ID (ECGI) report of the conflicting cells from its UEs, which in the above example results in both PCIDs in the list having the same ECGI, revealing that there is only one real cell with the PCID in question and the neighbour list/NRT can be so corrected. Of course, if in another example TC1 and TC4 have the same PCID, a ECGI report will reveal that there are actually two real neighbour cells with the same PCID. Second, the eNB can determine whether two reported PCIDs refer to the same real cell by checking to see which if any of the co-sited local cells were included in the qualifying neighbour report. For example, if TC1 and TC4 have the same PCID, and UE1 and UE2 are both served by cell C3, then the two reports with the same PCID will also include strong reports of C1 or C2, but not both. In most cases, neighbours with conflicting PCIDs are likely to be reported at opposite extremes of the serving cell area, and the pattern of the cells reported can be used to decide whether the reports correspond to the same or different cells.

An example NRT is shown in Table 1, which shows a list of particular neighbour relations (NR). Each NR includes a local cell identification (LCI) belonging to the serving eNB, and a neighbouring (potential handover target) cell identification (TCI) which can include a ECGI and a PCID for intra-frequency neighbours, and additionally a centre frequency for other-frequency neighbours. It should be noted that the columns entitled No removal, No HO, and No X2 are examples of OAM system controlled neighbour relation attributes assigned by the OAM system in the NRT, and that these attributes (No removal, No HO, and No X2) are not pertinent in the present invention, but are presented for completeness.

TABLE 1
Neighbour Relation Table

| NR | CI | TCI | No removal | No HO | No X2 |
|---|---|---|---|---|---|
| 1 | C1 | TC1 | | | |
| 2 | C2 | TC2 | | | |

In the first scenario above, where there is a new neighbour cell with the same PCID in the NRT as a previous cell that is no longer a real neighbour for a local cell, even though the serving eNB still keeps it in the NRT based on the UE report for the same PCID of the previous cell, the OAM system will set this NR entry to the correct cell. This can be done by either changing the ECGI of the listing to the new neighbour cell, or by removing the incorrect NR line item and adding a new line item with the new neighbour cell with the correct ECGI. For example, if NR 1 is the erroneous line item, the OAM system can change the incorrect TC1 entry to another TCI (e.g., TC3) with the same PCID, or the OAM system can remove the row NR 1 and add another row NR 3 (not shown) for C1 with the another TCI (e.g., TC3) with the same PCID.

In the second scenario above, it is detected that there are two or more cells with the same PCID that are actual real neighbours of a local cell. Such cells, which are not in the NRT yet, can be added to the NRT with their reported ECGI, as reflected in Table 2.

TABLE 2
Neighbour Relation Table

| NR | CI | TCI | No removal | No HO | No X2 |
|---|---|---|---|---|---|
| 1 | C1 | TC1 | | | |
| 2 | C2 | TC2 | | | |
| 3 | C1 | TC4 | | | |

For example, if the OAM system detects the conflicting PCIDs, the OAM system can add a new row (NR 3) for local cell 1 (C1) with TC4 as a neighbour which has the same PCID as TC1. Alternatively, the eNB may be able to locally detect (without OAM system help) that two neighbour cells have the same physical cell ID. To do this, the eNB will profile the reports for other cells associated with reports for a given PCID. Then the eNB will attempt to detect whether there is strong clustering, i.e. whether strong reports of a certain PCID are associated with markedly different sets of reports of the other cells (e.g. the two co-sited cells). If this is the case, then the eNB will trigger the UEs to report ECGI to detect whether in fact there are two cells with the same PCID. If they are two real cells, the eNB can add (NR 3) the conflicting cell into the NRT with its ECGI and PCID. It should be noted that even if the OAM system or eNB detect two real conflicting PCIDs and add them to the NRT with their proper ECGI, the eNB will receive real-time reports from UEs possibly requiring handover. However, these real-time reports do not contain the ECGI, so the eNB will still not know the exact target cell. For example, in Table 3, there may be two line items, NR1 and NR3, where TC1 has a PCID and a ECGI, and TC4 has the same PCID but a different ECGI. Since a UE will only report PCID, a serving eNB will not know exactly which cell the UE is reporting. The present invention can resolve this ambiguity in three ways, as described below.

TABLE 3
Neighbour Relation Table

| NR | CI | TCI | No removal | No HO | No X2 |
|---|---|---|---|---|---|
| 1 | C1 | TC1 | | | |
| 2 | C2 | TC2 | | | |
| 3 | C1 | TC4 | | | |

In a first embodiment, when a serving eNB receives the UE report with a PCID from a neighbour cell, and if there are two or more cells with the same PCID (but different ECGIs) in the NRT, the serving eNB can ask the UE to report the ECGI of the cell in this report. Since this would increase load, an optional condition for asking for the ECGI could be, if the signal of that reported cell reaches the target to be a candidate for handover, only then would the eNB ask for the ECGI (to reduce the air interface load). This first resolution can get an eNB to have a clear association between the UE reports and the neighbour cells in NRT to avoid the incorrect selection of the cells for handover. In a specific example, an eNB receives the UE report from local cell (C1) with the same PCID in TC1 and TC4 in the NRT. The eNB then asks the UE to report the ECGI of this cell. The UE then reports the ECGI of this cell to the eNB, which is then able to tell if the cell is TC1 or TC4.

In a second embodiment, the eNB can analyze the reports on the same PCID outside of a handover situation, and build up a profile of the other cell reports associated with a given instance of each of the two clashing PCIDs. This can be used to resolve ambiguity when there is no time to request ECGI confirmation before handover. Given that most LTE deployments will have three co-located cells in one site, this can be used to simplify the neighbour profiling. As previously noted, conflicting PCIDs are likely to be at opposite ends of a cell's coverage. In the local cell case, this would mean that typically, one of these neighbours would show up on one extreme side of the cell's azimuth, and the other neighbour on the other extreme side of the cell's azimuth. It is likely therefore that the neighbour report on one is likely to include a report on one of the serving cell's co-sited cells, while the neighbour report on the other is likely to report the other co-sited cell. A UE close enough to the serving cell to report both co-sited cells as neighbours, is unlikely to see conflicting PCIDs. So for any neighbour report, the likelihood of conflicts can be estimated based on whether it also includes a report on one or other of the co-sited cells. Neighbours stored in the NRT should also record which if any of the co-sited cells were included in the qualifying report.

In a third embodiment, the eNB can pass the PCID clash information to one of the conflicting eNB neighbour cells. This PCID clash indication can be sent via an X2 peer-to-peer message. The message can direct the conflicting eNB to reconfigure its PCID and hence resolve the conflict.

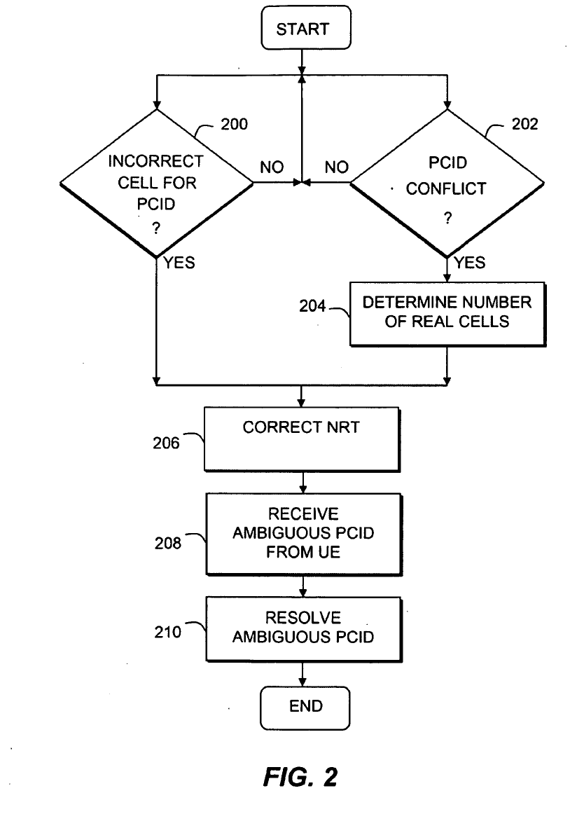

FIG. 2 illustrates an example of method for resolving conflicts of physical cell identification in a wireless communication system. The method initiates in step of detecting a PCID conflict. The PCID conflict can comprise either the detection in the NRT of a single PCID that is listed in error 200 or the presence of multiple identical PCIDs 202. If there is only a single PCID listed in error 200 the method proceeds with step 206.

For a multiple identical PCID conflict 202, the method includes a next step 204 of determining whether there is more than one real cell with the conflicting PCID. For example, two listings of the same PCID may simply reflect two different reports of the same cell, i.e. there is only one real cell with the PCID, but there are multiple reports of it. Alternatively, two listings of the same PCID may actually reflect the presence of two real cells that happen to share the same PCID. In order to determine whether there are one or multiple real cells with that PCID, an OAM system can either ask a UE to report a ECGI of the conflicting cells, or can check to see if the conflicting cells are actually co-located. If the ECGIs are the same or the cells are co-located this means that there is only one real cell. Otherwise there are multiple cells with conflicting PCIDs.

From either of the above steps 200, 204, the method includes a next step 206 of correcting the neighbour relation table in response to the PCID conflict. This can include adding a new correct entry to the NRT or removing an erroneous entry and adding a correct entry.

Even with a correct NRT, a UE can send ambiguous PCID reports, such as during handover. The ambiguity arises since a UE will typically only report PCID without ECGI, and if there are multiple real cell PCID entries in the NRT, there is no way to know on which cell the UE is reporting. Accordingly, the method includes a next step 208 of receiving an ambiguous PCID from a UE.

The method includes a next step 210 of resolving the ambiguous PCID. This can occur in one of three ways, in accordance with the present invention. First, the eNB can ask the UE for the corresponding ECGI for its PCID report, thereby resolving the ambiguity directly. Preferably, this is only done if the cell with the ambiguous PCID is a candidate for handover. Second, the eNB can analyze the reports on the same PCID outside of a handover situation, and build up a profile of the other cell reports associated with a given instance of each of the two clashing PCIDs of the multiple real physical cell identifications. Third, a message can be sent, by the UE or eNB, to one of the conflicting eNB neighbour cells to direct the conflicting eNB to reconfigure its PCID.

Advantageously, the present invention provides a technique for cells to resolve their own PCID conflicts with neighbouring cells in order to self-determine unique PCIDs, thereby it is helpful to adjust its own PCID to resolve the conflicts, and reduce the need for a central network entity to assign physical cell identifications.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for resolving conflicting physical cell identification in a wireless communication system, the method comprising the steps of:
detecting a physical cell identification conflict;
correcting a neighbour relation table in response to the conflict;
receiving an ambiguous physical cell identification; and
resolving the ambiguous physical cell identification.

2. The method of claim 1, wherein the detecting step includes detecting in the neighbour relation table a single physical cell identification that is listed in error.

3. The method of claim 1, wherein the detecting step includes detecting in the neighbour relation table multiple identical physical cell identifications.

4. The method of claim 3, further comprising a step of determining whether there is more than one real cell with the conflicting physical cell identification.

5. The method of claim 1, wherein the correcting step includes at least one of the group of: adding a new correct entry to the neighbour relation table, and removing an erroneous entry from the neighbour relation table.

6. The method of claim 1, wherein the resolving step includes asking for a corresponding global cell identification for the ambiguous physical cell identification.

7. The method of claim 6, wherein the asking substep is performed only if the cell with the ambiguous physical cell identification is a candidate for handover

8. The method of claim 1, wherein when there are multiple real physical cell identifications, the resolving step includes analyzing reports on the identical physical cell identifications, and building up a profile of other cell reports associated with a given instance of each of the multiple real physical cell identifications.

9. The method of claim 1, wherein the resolving step includes sending a message to a neighbour cell having a conflicting physical cell identification to direct that neighbour cell to reconfigure its physical cell identification.

10. A method for resolving conflicting physical cell identification for cells in a wireless communication system, the method comprising the steps of:
detecting in a neighbour relation table multiple identical conflicting physical cell identifications of cells;
determining whether there is more than one real cell with the conflicting physical cell identification;
correcting the neighbour relation table in response to the conflict;
receiving an ambiguous physical cell identification of a cell; and
resolving the ambiguous physical cell identification of the cell.

11. The method of claim 10, wherein the resolving step includes asking for a corresponding global cell identification for the ambiguous physical cell identification if the cell with the ambiguous physical cell identification is a candidate for handover

12. The method of claim 10, wherein the resolving step includes analyzing reports on the identical physical cell identifications, and building up a profile of other cell reports associated with a given instance of each of the multiple real physical cell identifications.

13. The method of claim 10, wherein the resolving step includes sending a message to a neighbour cell having a conflicting physical cell identification to direct that neighbour cell to reconfigure its physical cell identification.

14. A network entity operable to resolve conflicting physical cell identification in a wireless communication system, the network entity comprising:
a processor operable to detect a physical cell identification conflict, correct a neighbour relation table in response to the conflict, receive an ambiguous physical cell identification, and resolve the ambiguous physical cell identification.
